(19) United States
(12) Patent Application Publication
(10) Pub. No.: US 2025/0116779 A1
(43) Pub. Date: Apr. 10, 2025

(54) THREE-DIMENSIONAL MAPPING USING A LIDAR-EQUIPPED SPINNING PROJECTILE

(71) Applicant: Microchip Technology Incorporated, Chandler, AZ (US)

(72) Inventor: Valentin Stoia, Bucharest (RO)

(73) Assignee: Microchip Technology Incorporated, Chandler, AZ (US)

(21) Appl. No.: 18/539,774

(22) Filed: Dec. 14, 2023

Related U.S. Application Data
(60) Provisional application No. 63/542,576, filed on Oct. 5, 2023.

(51) Int. Cl. G01S 17/894; G01S 7/48; G01S 7/484; G01S 7/4865; G01S 7/51; G01S 17/10

(52) U.S. Cl. CPC G01S 17/894; G01S 7/4808; G01S 7/484; G01S 7/4865; G01S 7/51; G01S 17/10

(57) ABSTRACT

A method for using a LIDAR-equipped projectile for three-dimensional mapping including sending a signal to a light source to cause the light source to emit a plurality of light pulses, the light source located on a spinning projectile proceeding along a predetermined path; receiving, at the spinning projectile, a plurality of reflected light pulses responsive to the plurality of light pulses reflecting off an object or a terrain portion; determining a distance of the object or the terrain portion from the light source; and generating a three-dimensional map of the object based on the determined distance of the object or the terrain portion from the light source.

### PRIORITY

This application claims priority to U.S. Provisional Patent Application No. 63/542,576, filed Oct. 5, 2023, the contents of which are hereby incorporated in their entirety.

### TECHNICAL FIELD

The present disclosure relates to three-dimensional mapping of landscapes and structures utilizing a projectile.

### BACKGROUND

In certain applications there is a need to map a landscape, including objects and obstacles, where the observer does not have a direct line of sight to the landscape, or such a line of sight may be difficult to utilize. For example, in a military application, soldiers may desire to know the landscape and obstacles before them to know enemy positions, identify weapons, and discover defensive structures. Another example, in an industrial application, may involve an interior space, such as a large pipeline where interior obstructions and fractures are to be located and identified.

Three-dimensional mapping may be difficult if there are random obstacles blocking the view and narrow gaps are not sufficient to provide sufficient useful data. Prior systems use cameras to photograph the environment and then build three-dimensional photographic reproductions. A camera fitted to the end of a cable has limited range and may use a vehicle to carry the camera. A drone may carry a camera, but drones tend to be large, slow, expensive (particularly, if lost), and noisy. Thus, there is a need to three-dimensionally map landscapes and structures that may be difficult to traverse.

### SUMMARY OF THE INVENTION

Aspects provide systems and methods for using a LIDAR-equipped projectile for three-dimensional mapping. A method including sending a signal to a light source to cause the light source to emit a plurality of light pulses, the light source located on a spinning projectile proceeding along a predetermined path; receiving, at the spinning projectile, a plurality of reflected light pulses responsive to the plurality of light pulses reflecting off an object or a terrain portion; determining a distance of the object or the terrain portion from the light source; and generating a three-dimensional map of the object or the terrain portion based on the determined distance of the object or the terrain portion from the light source.

A projectile including a LIDAR scanner; a LIDAR sensor; and a control circuit to: emit a light pulse via the LIDAR scanner; receive a reflected light pulse via the LIDAR sensor, wherein the reflected light pulse is responsive to the light pulse reflecting off an object or a terrain portion; record a first time at which the light pulse is emitted; and record a second time at which the reflected light pulse is received.

A system including a control circuit to: receive a signal from a light source installed on a projectile indicating a plurality of first times at which the light source emitted a plurality of light pulses; receive a signal indicating a plurality of second times at which a plurality of reflected light pulses are received at the projectile, wherein the plurality of reflected light pulses are responsive to the plurality of light pulses reflecting off an object or a terrain portion; determine a distance of the object from the light source; and generate a three-dimensional map of the object or the terrain portion.

### BRIEF DESCRIPTION OF THE DRAWINGS

Example aspects of the present disclosure are described below in conjunction with the figures, in which:

FIG. 1 illustrates a block diagram of a system for using a LIDAR-equipped spinning projectile for three-dimensional mapping;

FIG. 2 is a block diagram of a system for using a LIDAR-equipped spinning projectile for three-dimensional mapping with a separate base unit;

FIG. 3 is a perspective view of a projectile used in the system of FIG. 1 or 2;

FIG. 4 illustrates a method performed by a control circuit used in a spinning projectile providing three-dimensional mapping; and

FIG. 5 illustrates a method performed by a control circuit used in a launch device or base unit to provide three-dimensional mapping.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect, a projectile may be fitted with light detection and ranging (LIDAR) devices, a gravity-axis sensor, and a radio frequency (RF) transmitter. A base station may have an RF receiver, a control circuit, and a display. A gun or other launch device may propel the projectile into flight and may cause the projectile to spin throughout its flight so that any point radially removed from a longitudinal axis of the projectile may follow a spiral path. The launch device may be aimed in the target direction to launch the projectile along an intended flight path. The projectile may penetrate narrow spaces and data collected by the LIDAR devices may be used to provide three-dimensional area mapping.

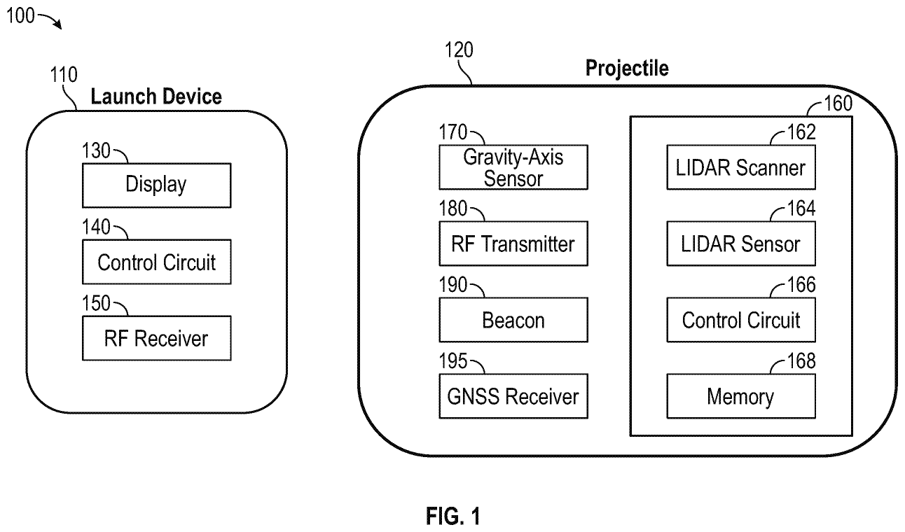

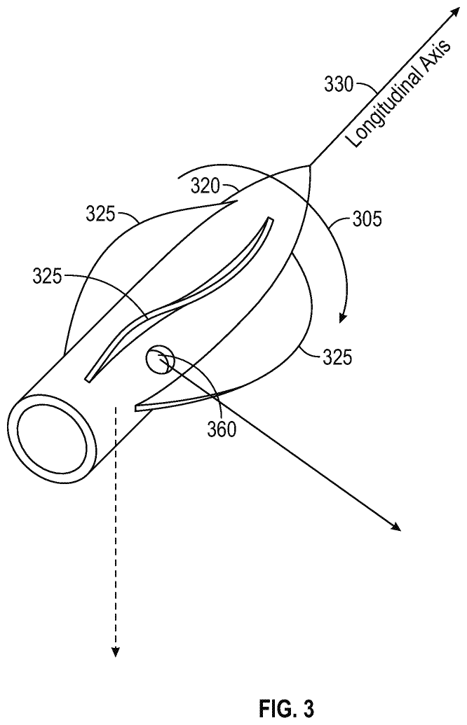

FIG. 1 illustrates a block diagram of a system for using a LIDAR-equipped spinning projectile for three-dimensional mapping. System 100 includes launch device 110 and projectile 120. Launch device 110 may be any device used to shoot, launch, or otherwise propel projectile 120. Launch device 110 may cause projectile 120 to spin about a longitudinal axis of projectile 120 while projectile 120 is in flight so that any point radially removed from the longitudinal axis of projectile 120 may follow a spiral path. For example, launch device 110 may have a barrel with internal rifling through which projectile 120 is pressed to cause the spinning flight of projectile 120. Alternatively, launch device 110 may have a smooth bore barrel and projectile 120 may be equipped with airfoils or wings to cause projectile 120 to spin during flight as described in more detail with respect to FIG. 3.

Launch device 110 may include display 130, control circuit 140, and RF receiver 150. Display 130 may be used to display a three-dimensional map or image of the environment, e.g., terrain, and objects along the flight path of projectile 120. Display may be a liquid crystal display (LCD), a light emitting diode (LED) display, a plasma display, an organic light emitting diode (OLED) display, or any other suitable display.

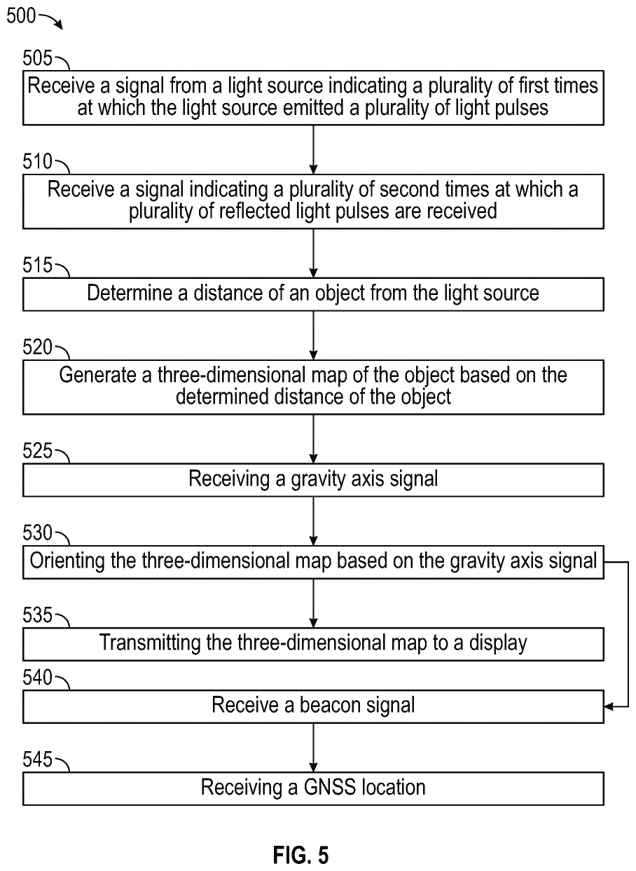

Control circuit 140 may be implemented in any suitable combination of analog and digital circuitry, such as a suitable microprocessor, microcontroller, control board, or other computing device having input and output interfaces for communicating with other devices, as well as memory or other storage for program logic/instructions that control circuit 140 executes to send and receive signals and process data. Control circuit 140 may receive data from projectile 120, process the data, and generate a three-dimensional map or image of the area surveyed by projectile 120 on display 130, as described in more detail with respect to FIG. 5.

RF receiver 150 may include an antenna and receiver circuit (not expressly shown) to receive wireless transmissions from projectile 120. RF receiver 150 may communicate using any suitable wireless communications RF protocol. The RF protocol may be with data encryption or without data encryption when low latency may be desired. In some examples, RF receiver 150 may use a peer-to-peer network to communicate with projectile 120.

Projectile 120 may be a single-use device or a multi-use device. Projectile 120 may include LIDAR device 160, gravity-axis sensor 170, RF transmitter 180, beacon 190, and global navigation satellite system (GNSS) receiver 195. GNSS receiver 195 may be a global positioning satellite (GPS) receiver.

LIDAR device 160 may include a LIDAR scanner 162, a LIDAR sensor 164, control circuit 166, and memory 168. LIDAR scanner 162 is a light source that may emit rapid pulses of ultraviolet, visible or near-infrared laser light into the environment surrounding projectile 120. These pulses, traveling at the speed of light, bounce off surrounding objects or terrain portions, and the reflected light pulses return to LIDAR sensor 164. LIDAR sensor 164 detects and collects data regarding the returning reflected light pulses, including, without limitation, the amount of time elapsed between transmission of a respective light pulse by LIDAR scanner 162 and receipt of reflected light energy responsive to the respective light pulse. While only a single LIDAR sensor 164 is shown, this is not meant to be limiting in any way. In some examples, multiple LIDAR sensors 164 are provided. Control circuit 166 may be implemented in any suitable combination of analog and digital circuitry, such as a suitable microprocessor, microcontroller, control board, or other computing device having input and output interfaces for communicating with other devices, as well as memory 168 or other storage for program logic/instructions that control circuit 166 executes to send and receive signals and process data. Memory 168 may be random access memory (RAM), read-only memory (ROM), volatile, non-volatile, registers, or any other suitable memory.

Control circuit 166 may measure the difference between the emission time of a respective light pulse by LIDAR scanner 162 and receipt time of reflected light energy responsive to the respective light pulse of some, or all of the pulses and may calculate the distance traveled by each pulse to compile a dataset called a LIDAR point cloud. Because the speed of laser light is constant, control circuit 166 may use the “time of flight” to calculate very precise distances of surrounding objects or terrain portions. These distances may be used to create a three-dimensional map of the surrounding objects or terrain portions along the flight path of projectile 120. In some examples, the data regarding the emitted pulses and reflected light pulses may be transmitted to launch device 110 by control circuit 166 utilizing RF transmitter 180 and the data may be processed by control circuit 140 to create the LIDAR point cloud and three-dimensional map.

LIDAR scanner 162 may be positioned with respect to projectile 120 such that LIDAR scanner 162 emits a beam of light or infrared beam substantially at a right angle to the flight path of projectile 120, i.e. to a longitudinal axis of projectile 120. For example, LIDAR scanner 162 may be positioned on the side of projectile 120. Similarly, LIDAR sensor 164 may also be positioned on the side of projectile 120, adjacent to, or opposite, or at any appropriate location in respect to, LIDAR scanner 162. As projectile 120 spins through the air along its typically horizontal flight path, the beam of light emitted by LIDAR scanner 162 sweeps across the terrain in a direction substantially perpendicular to the flight path of projectile 120.

Gravity-axis sensor 170 may be a sensor that determines the direction of gravity such that the three-dimensional map produced by control circuit 140 may be oriented in reference to the Earth's surface. Gravity-axis sensor 170 may be an accelerometer or any other suitable sensor for detecting the direction of the Earth's gravity.

RF transmitter 180 is used to communicate information from LIDAR device 160 to RF receiver 150 on launch device 110. For example, RF transmitter 180 may communicate data from LIDAR device 160, gravity-axis sensor 170, and GNSS receiver 195 to launch device 110. RF transmitter 180 may communicate with RF receiver 150 using any suitable RF or peer-to-peer protocol. The RF protocol may be without data encryption, as low latency may be desired. In some examples, RF transmitter 180 may use a peer-to-peer network to communicate with launch device 110.

Beacon 190 may be included in projectile 120 to assist users in locating and retrieving projectile 120 after use. Beacon 190 may be a radar reflector, a radio, sonic, or visual beacon, or any other suitable device used to locate projectile 120.

GNSS receiver 195 may be included in projectile 120 in addition to beacon 190 or as an alternative to beacon 190 to assist users in locating and retrieving projectile 120 after use. GNSS receiver 195 may locate global navigation satellites, determine the distance to each satellite, and use the distance information to determine the location of the projectile 120. The location information may be transmitted back to launch device 110 using RF transmitter 180. Thus, in some examples, beacon 190 may not be provided. In another example, information received from the GNSS receiver 195 may be transmitted to launch device 110, which may determine the distance to each satellite, and use the distance information to determine the location of the projectile 120.

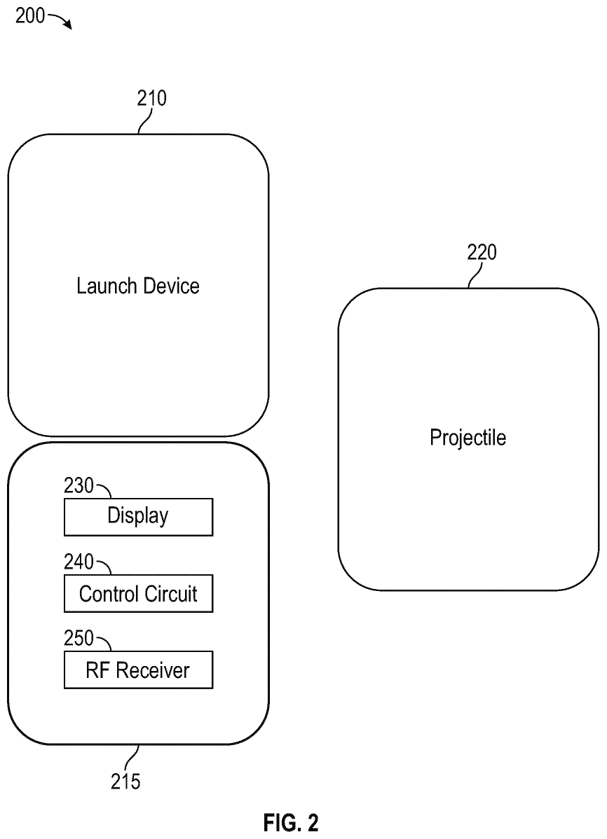

FIG. 2 is a block diagram of a system for using a LIDAR-equipped spinning projectile for three-dimensional mapping with a separate base unit. In some examples, one or more of display 130, control circuit 140, and RF receiver 150, shown in FIG. 1, may be in a device separate from launch device 110, as shown in FIG. 2.

System 200 includes base unit 215 separate from launch device 210. Launch device 210 may be similar to launch device 110 in that it is any device used to shoot or launch projectile 220. Launch device 210 may cause projectile 220 to spin when projectile 220 is in flight so that any point radially removed from the longitudinal axis of projectile 220 may follow a spiral path. For example, launch device 210 may have a barrel with internal rifling through which projectile 220 is pressed to cause the spinning flight of projectile 220. Alternatively, launch device 210 may have a smooth bore barrel and projectile 220 is equipped with airfoils or wings to cause projectile 220 to spin during flight. Projectile 220 may be similar to projectile 120 described with respect to FIG. 1.

Base unit 215 may perform RF data receiving and processing and may be separate from launch device 210. Base unit 215 may contain display 230, control circuit 240, and RF receiver 250. Display 230, control circuit 240, and RF receiver 250 may be similar to display 130, control circuit 140, and RF receiver 150, respectively, described with respect to FIG. 1. In some examples, base unit 215 may be a personal computer, handheld computer, or wearable device.

FIG. 3 is a perspective view of a projectile used in the system of FIG. 1 or 2. Projectile 320 may be similar to projectile 120 or projectile 220 described with respect to FIGS. 1 and 2, respectively. Projectile 320 includes LIDAR device 360 which may be similar to LIDAR device 160 described with respect to FIG. 1. As indicated above, while LIDAR device 360 is illustrated as being in a single location at an outer portion of projectile 320, LIDAR device 360 may comprise a plurality of LIDAR sensors 164, which plurality of LIDAR sensors 164 may be located equally spaced circumferentially about the projectile body so as to detect reflection irrespective of the rotational position of the projectile body when the reflection is received. In other examples, multiple LIDAR scanner 162 and LIDAR sensor 164 pairs may be provided, equally spaced circumferentially about the projectile body, so as to emit light pulses and detect light reflection irrespective of the rotational position of the projectile body when the pulse is transmitted. One or more control circuits 166 may be provided for the plurality of LIDAR sensors 164, or for the plurality of multiple LIDAR scanner 162 and LIDAR sensor 164 pairs.

In flight, projectile 320 spins about longitudinal axis 330 of projectile 320 in direction 305. The velocity of projectile 320 may be subsonic (less than about 340 m/s in dry air at sea level). In some examples, projectile 320 may begin to spin while launched from a launch device having a barrel with internal rifling. Alternatively, or in addition to, projectile 320 may spin due to airfoils 325 on the outer surface of projectile 320. Airfoils 325 may be arranged in a spiral pattern such that airfoils 325 cause projectile 320 to spin about longitudinal axis 330 as air flows around airfoils 325. Airfoils 325 may also provide additional in-flight stability as projectile 320 travels along its flight path.

LIDAR device 360 may be positioned on the longitudinal side of projectile 320 such that it emits a beam of light or infrared beam substantially at a right angle to the flight path of projectile 320. Therefore, as projectile 320 spins through the air along its typically horizontal flight path, the beam of light emitted by LIDAR device 360 sweeps across the terrain in a direction substantially perpendicular to the flight path of projectile 320.

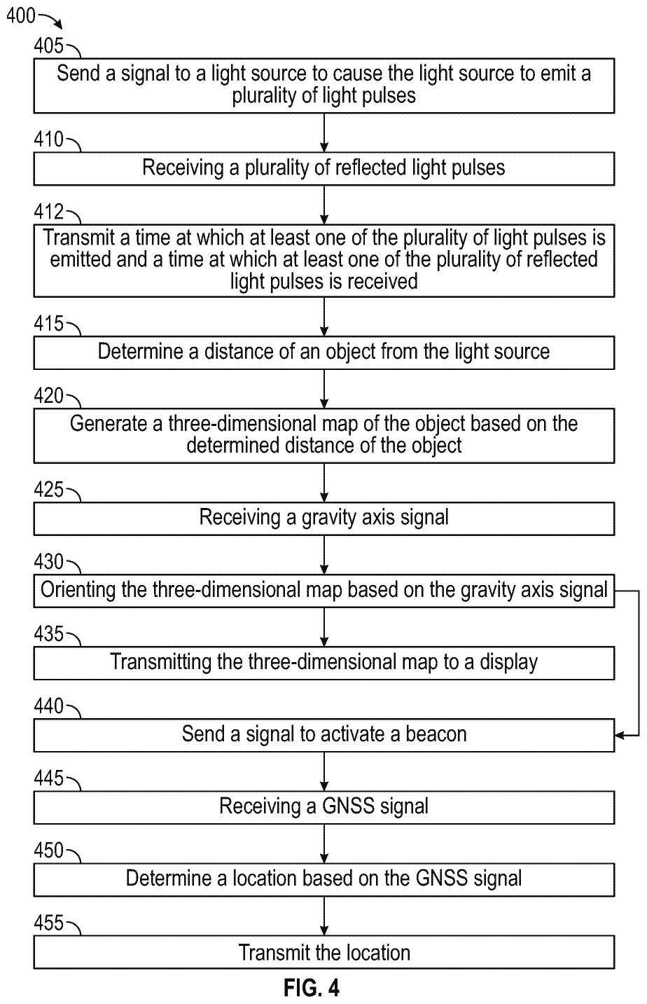

FIG. 4 illustrates a method performed by a control circuit used in a spinning projectile providing three-dimensional mapping. Method 400 may be implemented using a control circuit such as control circuit 166 in communication with control circuit 140, or any other system operable to implement method 500. Although examples have been described above, other variations and examples may be made from this disclosure without departing from the spirit and scope of these disclosed examples. Thus portions of the method may be performed by control circuit 166 and portions of the method may be performed by control circuit 140 or control circuit 240, without limitation.

Method 400 begins at block 405 where the control circuit, e.g., control circuit 166, may send a signal to a light source to cause the light source to emit a plurality of light pulses. The light source may be a LIDAR scanner, such as LIDAR scanner 162 shown in FIG. 1. The light source may emit rapid pulses of ultraviolet, visible, or near-infrared laser light into the environment surrounding the light source.

At block 410, the control circuit, e.g., control circuit 166, may detect the receipt of a plurality of reflected light pulses. The pulses emitted by the light source at block 405 may bounce off objects or portions of the terrain in the environment surrounding the light source and the reflected light pulses return to a sensor, such as LIDAR sensor 164 shown in FIG. 1.

At block 412, the control circuit, e.g., control circuit 166, may transmit a time at which at least one of the plurality of light pulses is emitted and a time at which at least one of the plurality of reflected light pulses is received. The control circuit may transmit these times to the launch device or a base unit, such as launch device 110 or 210 or base unit 215 using an RF transmitter, such as RF transmitter 180. The control circuit may also record the times in a memory, e.g., memory 168 shown in FIG. 1.

At block 415, the control circuit, e.g., control circuit 140 or control circuit 240, may determine a distance of an object from the light source. The control circuit may measure the difference between the emission times of the pulses emitted at block 405 and return times of the reflected pulses detected at block 410 and calculate the distance traveled by each pulse to compile a dataset called a LIDAR point cloud. Because the speed of laser light is constant, the control circuit may use the “time of flight” to calculate very precise distances of objects or terrain as the projectile proceeds over the flight path. At block 420, the control circuit may generate a three-dimensional map of the object or terrain based on the distance determined at block 415. In some examples, block 420 may be performed by control circuit 140 or control circuit 240 after receipt of data from control circuit 166 transmitted through RF transmitter 180 (block 412) and received by RF receiver 150 or RF receiver 250.

At block 425, the control circuit, e.g., control circuit 140 or control circuit 240, may receive a gravity axis signal indicating the direction of the Earth's surface. In some examples, information regarding the gravity axis signal block may be transmitted through RF transmitter 180 and received by RF receiver 150 or RF receiver 250. The gravity axis signal may be from a gravity-axis sensor, such as gravity-axis sensor 170 shown in FIG. 1. At block 430, the control circuit may orient the three-dimensional map generated at block 420 relative to the Earth's surface using the gravity axis signal received at block 425. In some examples, block 430 may be performed by control circuit 140 or control circuit 240. In another example, one or more of blocks 415-430 may be performed by control circuit 166, i.e., by the projectile, with the resultant information transmitted to control circuit 140 or control circuit 240. Thus, for example, the control circuit of the projectile may determine a distance of the object from the LIDAR scanner; and generate a three-dimensional map of the object or terrain portion.

At block 435, the control circuit may transmit the three-dimensional map to a display. The display may be on the launch device, such as display 130 shown in FIG. 1, or on a base unit, such as display 230 shown in FIG. 2. The display may allow a user to interact with the map. Block 430 may be performed by control circuit 140 or control circuit 240. In some examples, the control circuit may transmit the three-dimensional map using a peer-to-peer communications link.

At block 440, the control circuit may send a signal to activate a beacon. The beacon may be on the projectile to assist in locating and retrieving the projectile. In some examples, block 440 may be performed by control circuit 140 or control circuit 240 transmitting a signal to control circuit 166 through RF receiver 150 for receipt by a receiver in projectile 120. Control circuit 166, upon receipt of the signal, may activate beacon 190.

At block 445, the control circuit, e.g. control circuit 166, may receive a GNSS signal. The GNSS signal may be from a GNSS receiver on the projectile, such as GNSS receiver 195 shown in FIG. 1. Using the GNSS signal, at block 450, e.g., control circuit 166, the control circuit may determine a location of the projectile. At block 455, the control circuit, e.g. control circuit 166, may transmit the location determined at block 450 to a launch device or a base unit to assist in locating and retrieving the projectile. In one example, information from the GNSS receiver is transmitted to control circuit 140 or control circuit 240, and control circuit 140 or control circuit 240 may determine a location of the projectile at least partially responsive to the information from the GNSS receiver. In such an example, block 450 may be performed by control circuit 140 or control circuit 240 in response to data transmitted regarding the received GNSS signal, and block 455 may comprise transmission of the determined location of the projectile to a display.

Although FIG. 4 discloses a particular number of operations related to method 400, method 400 may be executed with greater or fewer operations than those depicted in FIG. 4. In addition, although FIG. 4 discloses a certain order of operations to be taken with respect to method 400, the operations comprising method 400 may be completed in any suitable order.

FIG. 5 illustrates a method performed by a control circuit used in a launch device or base unit to provide three-dimensional mapping. Method 500 may be implemented using a control circuit such as control circuit 140, control circuit 240, or any other system operable to implement method 500. Although examples have been described above, other variations and examples may be made from this disclosure without departing from the spirit and scope of these disclosed examples.

Method 500 begins at block 505 where the control circuit may receive a signal from a light source indicating a plurality of first times at which the light source emitted a plurality of light pulses. The light source may be a LIDAR scanner, such as LIDAR scanner 162 shown in FIG. 1. The light source may emit rapid pulses of near-infrared laser light into the environment surrounding the light source.

At block 510, the control circuit may receive a signal indicating a plurality of second times at which a plurality of reflected light pulses are received by a sensor. The pulses emitted by the light source may bounce off objects in the environment surrounding the light source and the reflected light pulses return to a sensor, such as LIDAR sensor 164 shown in FIG. 1.

At block 515, the control circuit may determine a distance of an object from the light source. The control circuit may measure the difference between the emission times of the pulses (received at block 505) and return times of the reflected pulses (received at block 510) and may calculate the distance traveled by each pulse to compile a dataset called a LIDAR point cloud. Because the speed of laser light is constant, the control circuit may use the “time of flight” to calculate very precise distances of surrounding objects or portions of terrain proximate the projectile. At block 520, the control circuit may generate a three-dimensional map of the object based on the distance determined at block 515.

At block 525, the control circuit may receive a gravity axis signal indicating the direction of the Earth's surface. The gravity axis signal may be from a gravity-axis sensor on a projectile, such as gravity-axis sensor 170 shown in FIG. 1. At block 530, the control circuit may orient the three-dimensional map generated at block 520 relative to the Earth's surface using the gravity axis signal received at block 525.

At block 535, the control circuit may transmit the three-dimensional map to a display. The display may be on the launch device, such as display 130 shown in FIG. 1, or on a base unit, such as display 230 shown in FIG. 2. The display may allow a user to interact with the map.

At block 540, the control circuit may receive a beacon signal from the projectile. The beacon signal may be used to assist in locating and retrieving the projectile.

At block 545, the control circuit may receive a GNSS location from the projectile. The GNSS location may be determined at the projectile using GNSS signals from a GNSS receiver on the projectile, such as GNSS receiver 195 shown in FIG. 1, to determine a location of the projectile. The control circuit may use the GNSS location to assist in locating and retrieving the projectile. In another example, information from the GNSS receiver on the projectile may be received, and the GNSS information may be used to determine a location of the projectile.

Although FIG. 5 discloses a particular number of operations related to method 500, method 500 may be executed with greater or fewer operations than those depicted in FIG. 5. In addition, although FIG. 5 discloses a certain order of operations to be taken with respect to method 500, the operations comprising method 500 may be completed in any suitable order.

Although examples have been described above, other variations and examples may be made from this disclosure without departing from the spirit and scope of these disclosed examples.

1. A method comprising:
sending a signal to a light source to cause the light source to emit a plurality of light pulses, the light source located on a spinning projectile proceeding along a predetermined path;
receiving, at the spinning projectile, a plurality of reflected light pulses, the plurality of reflected light pulses responsive to the plurality of light pulses reflecting off an object or a terrain portion;
determining a distance of the object or the terrain portion from the light source; and
generating a three-dimensional map of the object or the terrain portion based on the determined distance of the object from the light source.

2. The method of claim 1, comprising:
receiving a gravity axis signal from the projectile; and
orienting the three-dimensional map based on the gravity axis signal.

3. The method of claim 1, comprising:
sending a signal to activate a beacon.

4. The method of claim 1, comprising:
receiving a GNSS signal; and
determine a location of the projectile based on the received GNSS signal.

5. The method of claim 1, comprising:
transmitting the three-dimensional map to a display.

6. The method of claim 1, comprising transmitting a time at which at least one of the plurality of light pulses is emitted and a time at which at least one of the plurality of reflected light pulses is received, wherein the determining the distance of the object or the terrain portion from the light source is responsive to the transmitted time at which at least one of the plurality of light pulses is emitted and the time at which at least one of the plurality of reflected light pulses is received.

7. A projectile comprising:
a LIDAR scanner;
a LIDAR sensor; and
a control circuit to:
emit a light pulse via the LIDAR scanner;
receive a reflected light pulse via the LIDAR sensor, wherein the reflected light pulse is responsive to the light pulse reflecting off an object or a terrain portion;
transmit a first time at which the light pulse is emitted; and
transmit a second time at which the reflected light pulse is received.

8. The projectile of claim 7, comprising:
determine a distance of the object from the LIDAR scanner; and
generate a three-dimensional map of the object or terrain portion.

9. The projectile of claim 7, comprising:
a gravity axis sensor;
wherein the control circuit transmits information regarding a direction of gravity.

10. The projectile of claim 7, comprising:
a beacon;
wherein the control circuit causes the beacon to emit a beacon signal to locate the projectile.

11. The projectile of claim 7, comprising:
a GNSS receiver;
wherein the control circuit causes the GNSS receiver to determine the location of the projectile.

12. The projectile of claim 7, comprising:
an RF transmitter;
wherein the control circuit causes the RF transmitter to transmit the first and second times.

13. The projectile of claim 7, comprising:
an airfoil to cause the projectile to spin during flight.

14. The projectile of claim 7, wherein:
the LIDAR scanner and LIDAR sensor are positioned on a longitudinal side of the projectile; and
the LIDAR scanner emits the light pulse perpendicular to a longitudinal axis of the projectile.

15. A system comprising:
a control circuit to:
receive a signal from a light source installed on a projectile indicating a plurality of first times at which the light source emitted a plurality of light pulses;
receive a signal indicating a plurality of second times at which a plurality of reflected light pulses are received at the projectile, wherein the plurality of reflected light pulses are responsive to the plurality of light pulses reflecting off an object or a terrain portion;
determine a distance of the object or the terrain portion from the light source; and
generate a three-dimensional map of the object or the terrain portion.

16. The system of claim 15, the control circuit to:
receive a beacon signal from the projectile; and
locate the projectile based on the beacon signal.

17. The system of claim 15, the control circuit to:
receive information regarding a GNSS location from a projectile.

18. The system of claim 15, the control circuit to:
receive a gravity axis signal from a projectile; and
orient the three-dimensional map based on the gravity axis signal.

19. The system of claim 15, the control circuit to:
transmit an image of the three-dimensional map to a display.

20. The system of claim 19, wherein transmitting the image is performed over a peer-to-peer communication link.
